(19) United States
(12) Patent Application Publication
(10) Pub. No.: US 2023/0296180 A1
(43) Pub. Date: Sep. 21, 2023

(54) Double Seat Valve

(71) Applicant: GEA Tuchenhagen GmbH, Büchen (DE)

(72) Inventor: Jens Burmester, Grambek (DE)

(21) Appl. No.: 18/010,640

(22) PCT Filed: Jun. 14, 2021
(86) PCT No.: PCT/EP2021/065937

§ 371 Date: Dec. 15, 2022

(30) Foreign Application Priority Data
Jun. 16, 2020 (DE) 10 2020 003 565.5

(51) Int. Cl. F16K 1/44

(52) U.S. Cl. CPC F16K 1/446

(57) ABSTRACT

A double seat valve has a housing with first and second interiors. A passage connects the interiors, and first and second valve seats are arranged therein. The valve includes a first closing body, which has a cavity and is fastened to a rod, and a second closing body, through which the rod and can be brought into sealing contact with the first closing body. By contact with the first closing body, the cavity is sealed with respect to the second interior and with a closing body portion arranged on the second closing body and cooperates with a seal in the housing. To improve hygiene conditions, a flushing space and a hygiene structure cooperating with the space are provided. The second closing body can be brought into a position in which the closing body portion is withdrawn from the second interior in the flushing space and the seal is exposed.

### TECHNICAL FIELD

The invention relates to a double seat valve.

### BACKGROUND

Valves of the double seat type are used in systems for producing foodstuffs, beverages, medications, and fine chemical products as well as in biotechnology.

These applications require the double seat valve to have a hygienic design. This also applies to the locations at which rods, by means of which the closing bodies in the interior of the double seat valve can be adjusted, leave the directly product-conveying interior. At a location of this kind, a seal that slides on the rod can be provided. It is sensible to design said seal to be cleanable.

In the prior art, WO 2009/115255 A1 and EP 0 646 741 B1 disclose arrangements by means of which the seal can be exposed for cleaning in a cleaning step. Both documents disclose arrangements of this kind, and EP 0 646 741 B1 additionally discloses cleaning of the drive-side seal, which is designed to slide on a closing body portion. An even older document is DE 41 18 874 A1, which also discloses cleaning of the drive-side seal.

### SUMMARY

An object of the invention is to improve the hygienic conditions in the region of the closing body portion.

This object is achieved by means of a double seat valve as described herein.

A double seat valve is proposed that has a housing with a first interior and a second interior. A passage connects the interiors, and a first valve seat and a second valve seat are arranged in the passage. A first closing body has a cavity and is fastened to a rod. The rod passes through a second closing body that can be brought into sealing contact with the first closing body. By this contact, the cavity is sealed with respect to the second interior. A closing body portion is arranged on the second closing body and cooperates with a seal received in the housing. The double seat valve also includes a flushing space and a hygiene structure cooperating with the flushing space. The second closing body can be brought into a position in which the closing body portion is withdrawn from the second interior in the flushing space and the seal is exposed.

A flushing space denotes a cavity in the double seat valve in which a flow of a cleaning agent can be produced, generally a cleaning liquid, which cleans walls of the flushing space and surfaces of objects in the flushing space.

The first closing body and the rod may be integrally formed.

A hygiene structure denotes a formative element of or on the closing body portion and wall of the flushing space that directs, accelerates, or deflects a flow of a cleaning liquid.

The hygiene structure may advantageously comprise at least one of a spray nozzle body, a twist-off point on the closing body portion, or a contour of the closing body portion. The twist-off point is advantageously provided so as to adjoin an end, facing the second interior, of a sliding surface of the closing body portion on which the seal slides. The sliding surface may advantageously be cylindrical in shape to produce a uniform sealing effect in different positions of the seal and sliding surface. The seal and sliding surface are in sliding and sealing contact, wherein this contact can be released in some valve positions, for example a cleaning position.

The contour is advantageously designed such that a slope that acts like a funnel and directs liquid coming from the sliding surface to a drain directly adjoins the cylindrical portion of the sliding surface. This drain may be formed between the rod and the second closing body.

In a development, the twist-off point is arranged on the closing body portion, adjoins the sliding surface in the direction of the second interior, and forms a gap with the seal in a cleaning position of the closing body portion.

The gap generates a flow of the cleaning liquid that thoroughly cleans the seal and the sliding surface and thus improves the hygienic conditions in this region.

In a development, a housing cover is provided. The housing cover separates the second interior from the surroundings of the double seat valve. A flushing space in which the closing body portion can be received while also exposing the seal is formed in the housing cover. This design improves the hygienic conditions, since the closing body portion can be cleaned over a large area.

The flushing space is, in particular, a cavity that is adapted for receiving the closing body portion. It may advantageously be a recess in a housing cover that is pot-shaped or bowl-shaped, for example. The flushing space is filled completely or partially with the closing body portion in only some of the positions of the valve out of the open position, closed portion, and cleaning position. The wall of the flushing space may be designed to follow the contour of the closing body portion, wherein a distance between the wall and the contour is different depending on the position of the valve.

This cleanability is further improved in that the flushing space has sufficient dimensions to completely receive the closing body portion and to enclose same so as to form at least one gap. Only a side of the closing body portion that faces the second interior is exposed in the direction of the interior—the rest of the closing body portion is enclosed by the flushing space.

Another development relates to the spray nozzle body. It is structurally simple and advantageous for wetting of the closing body portion, in particular the slopes, to arrange the spray nozzle body in the flushing space so as to surround the hollow rod.

To improve the cleanability of the closing body portion in the direction of the second interior as well, according to one development, a surface normal of an underside of the closing body portion is inclined by a few degrees with respect to the stroke direction, such that a cone along the surface of which liquid flows off toward the center is formed.

The double seat valve designed with the above-described features has improved hygienic properties at the closing body portion because cleaning liquid can be flushed around said closing body portion in the position in which it is withdrawn into the flushing space, wherein the seal is also cleaned at the same time.

### BRIEF DESCRIPTION OF THE DRAWINGS

The invention will be explained in more detail below based on an exemplary embodiment and developments thereof. In addition, the advantages will be set out in more detail. The description will make reference to the drawings.

FIG. 1 shows a double seat valve in the closed position.

FIG. 2 shows a double seat valve in which the closing body portion is in the cleaning position.

### DETAILED DESCRIPTION

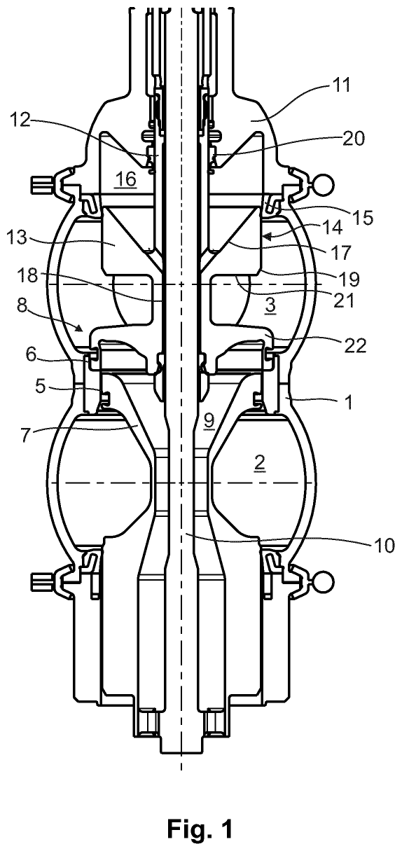

FIG. 1 shows a double seat valve for hygienic applications and in a hygienic design conceived for this purpose.

The double seat valve has a housing 1, in which a first interior 2 and a second interior 3 are formed. The interiors 2 and 3 are interconnected by means of a passage 4. A first valve seat 5 and a second valve seat 6 are formed in a wall of the passage 4.

A first closing body 7, which can be brought into sealing contact with the first valve seat 5, is received in the first interior 2 to project into the second interior 3. A second closing body 8, which can be brought into sealing contact with the second valve seat 6, is received in the second interior 3. The first closing body 7 has a cavity 9, which passes through in a stroke direction of the closing body.

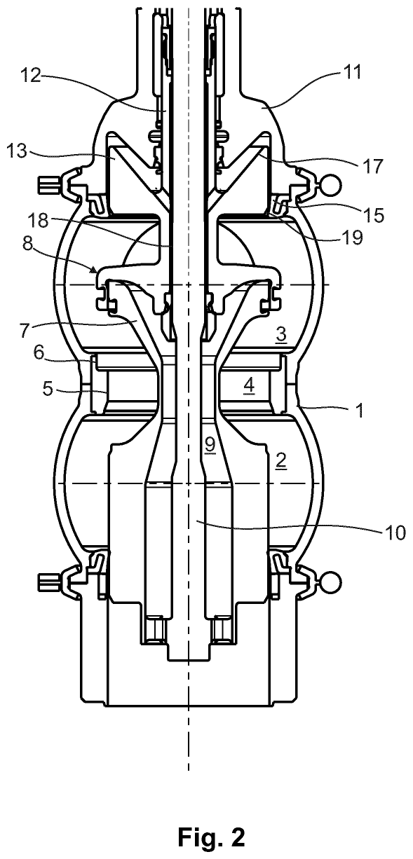

FIGS. 1 and 2 show positions of the closing body 7 and 8 of the double seat valve in which the cavity 9 is sealed with respect to the interiors 2 and 3. In FIG. 1, the case in which both closing bodies 7 and 8 are in sealing contact with the respectively assigned valve seat 5 and 6 is shown. The double seat valve is in a closed state, in which the interiors 2 and 3 are separated from one another. In FIG. 2, however, some of the first closing body 7 is received in a sealing manner in a recess of the second closing body 8. The cavity 9 is connected to the surroundings of the double seat valve, such that liquid escapes from the cavity 9 into said surroundings. Such liquid may be a leak due to a lack of contact between the closing body 7 and 8 and the assigned valve seat 5 and 6, for example in the event of a foreign body being trapped or due to wear of a seal. It may also be liquid during cleaning of the double seat valve.

A rod 10 passes through the cavity 9 inside the first closing body 7. The rod 10 extends through the second interior 3 and thereby passes through the second closing body 8. The second closing body 8 is connected to an adjustment apparatus (not shown), which causes a movement along a longitudinal axis of the rod 10. The adjustment apparatus may, for example, be designed to be operated by a pressure medium. Here, pneumatic systems, in particular, are known. Often, the second closing body 8 is passively designed for the main stroke, in that it is taken along by the first closing body 7 when the same moves into the open position. The adjustment apparatus is designed to individually actuate the closing bodies 7 and 8 in order to bring one of the closing bodies into a vented position so as to produce a small gap between the closing body 7 and 8 and the valve seat 5 and 6 while the other closing body 7 and 8 remains in the closed position, i.e., remains in sealing contact with the valve seat 5 and 6. Cleaning liquid enters the cavity 9 through the gap and is discharged through said cavity.

On the side facing the adjustment apparatus, the double seat valve has a housing cover 11, which separates the second interior 3 from the surroundings of the double seat valve. The rod 10 and a hollow rod 12 surrounding same are guided through the housing cover 11 and connect the closing bodies 7 and 8 to the adjustment apparatus.

The second closing body 8 has a closing body portion 13 oriented in the direction of the housing cover 11 and with an increased diameter, which produces an approximately dumbbell-like shape. The closing body portion 13 has a sliding surface 14, which may be designed to be cylindrical about the axis of movement and with respect to the hollow rod 12. A seal 15 received in the housing 1 is in sliding and sealing contact with said sliding surface 14. The seal 15 may be clamped between the housing 1 and the housing cover 11.

A flushing space 16, in which the closing body portion 13 can be received while at the same time exposing the seal 15, is formed in the housing 1, preferably in the housing cover 11. The term “expose” includes the formation of a gap between the seal 15 and the closing body portion 13. Preferably, the flushing space 16 has sufficient dimensions to completely receive the closing body portion 13 and to enclose the same to form at least one gap.

In FIG. 1, which shows the closed position of the double seat valve, the closing body portion 13 is located so far outside the flushing space 16 that only a small part of the sliding surface 14 is in sealing contact with the seal 15. In the position according to FIG. 2, the closing body portion 13 is withdrawn into the flushing space 16 and the seal 15 and sliding surface 14 are no longer in sealing contact. Instead of this contact, a gap is formed between the seal 15 and sliding surface 14, through which cleaning liquid that cleans the seal 15 and the sliding surface 14 can flow.

A slope 17 formed on the closing body portion 13 adjoins the sliding surface 14 and acts like a funnel and opens out into a drain 18, which is designed as a gap between the rod 10 and the second closing body 8. Said drain 18 creates a fluid connection between the flushing space 16 and the cavity 9.

During the cleaning step, cleaning liquid flows through the gap between the seal 15 and the closing body portion 13 and flows through the gap between the sliding surface 14 and an inner wall of the flushing space 16. The cleaning fluid then flows on the slope 17 directly adjoining the sliding surface 14. The funnel effect of the slope directs the liquid to the drain 18, from which the liquid then enters the cavity 9 and leaves the double seat valve through said cavity.

Due to the described design, the double seat valve has improved hygienic properties at the closing body portion 13. More particularly, cleaning liquid can be flushed around said closing body portion in the position in which it is withdrawn into the flushing space 16, wherein the seal 15 is also cleaned at the same time.

Another improvement can be achieved in that the closing body portion 13 has a twist-off point 19. Said twist-off point adjoins the sliding surface 14 in the direction of the second interior 3 and forms a gap with the seal 15 in the cleaning position of the closing body portion 13. This results in an improved cleaning effect.

An additional improvement of the hygienic properties is achieved by a spray nozzle body 20. Said spray nozzle body is arranged in the flushing space 16 to surround the hollow rod 12 and is designed such that as much as possible of the wall surfaces of the flushing space 16 and of the closing body portion 13, for example the slope 17, is wetted with cleaning agent.

The housing cover 11 may comprise an inlet for flushing agent and/or steam, which inlet may be fluidically connected to the spray nozzle body 20. This additionally improves the cleanability and thus the hygienic properties of the double seat valve.

The underside 21 of the closing body portion 13 facing the second interior 3 may advantageously be designed to equalize the pressure. This means an equalization of the forces that are exerted by a pressurized fluid in the second interior 3 on the closing portion 22 in a first direction and on the closing body portion 13 in the direction opposite the first direction. The equalization is achieved by selecting the surface area size of the underside 21 to match the size of the closing portion 22. The underside 21 may advantageously be designed as an almost horizontal surface of which the surface normal is parallel to the stroke direction. Advantageously, said surface is inclined by a few degrees in such a way that a cone is formed, along the surface of which liquid flows toward the center, in the direction of the rod 10.

The second closing body 8 may be formed of one piece. This improves the hygienic properties because interfaces are dispensed with between the portions, in particular the closing portion 22 and closing body portion 13 in the second interior 3, which are in contact with product.

The hygienic improvement measure demonstrated based on the example of a double seat valve can also be applied in other valves. The prerequisite is that the cleaning liquid can be discharged out of the flushing space 16. This can take place, for example, with a leakage chamber having a lateral outlet between the closing bodies.

A list of reference numbers used in this specification and the drawing figures is below.
1 Housing
2 First interior
3 Second interior
4 Passage
5 First valve seat
6 Second valve seat
7 First closing body
8 Second closing body
9 Cavity
10 Rod
11 Housing cover
12 Hollow rod
13 Closing body portion
14 Sliding surface
15 Seal
16 Flushing space
17 Slope
18 Drain
19 Twist-off point
20 Spray nozzle body
21 Underside
22 Closing portion

1. A double seat valve, comprising:
a housing with a first interior and a second interior;
a passage, which connects the first interior and the second interior, and in which a first valve seat and a second valve seat are arranged;
a first closing body, which has a cavity and which is fastened to a rod;
a second closing body, through which the rod passes, and which can be brought into sealing contact with the first closing body, by which contact the cavity is sealed with respect to the second interior;
a closing body portion, which is arranged on the second closing body and cooperates with a seal received in the housing; and
a flushing space and a hygiene structure cooperating with the flushing space, wherein the second closing body can be brought into a position in which the closing body portion is withdrawn from the second interior in the flushing space and the seal is exposed.

2. The double seat valve according to claim 1, wherein the closing body portion comprises a sliding surface in sliding and sealing contact with the seal.

3. The double seat valve according to claim 1, wherein the hygiene structure comprises at least one of a contour, a twist-off point, or a spray nozzle body.

4. The double seat valve according to claim 2, wherein the hygiene structure comprises a contour, and the contour comprises a slope that adjoins the sliding surface and acts like a funnel.

5. The double seat valve according to claim 4, wherein the slope opens out into a drain that is formed between the rod and the second closing body.

6. The double seat valve according to claim 2, wherein the hygiene structure comprises a twist-off point, and the twist-off point is arranged on the closing body portion, adjoins the sliding surface in a direction of the second interior, and forms a gap with the seal in a cleaning position of the closing body portion.

7. The double seat valve according to claim 1, comprising:
a housing cover that separates the second interior from surroundings of the double seat valve, wherein the flushing space is formed in the housing cover, and the closing body portion can be received in the housing cover while exposing the seal.

8. The double seat valve according to claim 7, wherein the hygiene structure comprises a spray nozzle body, and the spray nozzle body is arranged in the flushing space so as to surround a hollow rod.

9. The double seat valve according to claim 8, wherein the flushing space has sufficient dimensions to completely receive the closing body portion to form at least one gap.

10. The double seat valve according to claim 1, wherein a surface normal of an underside of the closing body portion is inclined by a few degrees with respect to a stroke direction, such that a cone along the surface of which liquid flows off toward the center is formed.

11. The double seat valve according to claim 2, wherein the hygiene structure comprises at least one of a contour, a twist-off point, or a spray nozzle body.

12. The double seat valve according to claim 11, wherein the contour comprises a slope that adjoins the sliding surface and acts like a funnel.

13. The double seat valve according to claim 12, wherein the slope opens out into a drain that is formed between the rod and the second closing body.

14. The double seat valve according to claim 12, wherein the twist-off point is arranged on the closing body portion, adjoins the sliding surface in a direction of the second interior, and forms a gap with the seal in a cleaning position of the closing body portion.

15. The double seat valve according to claim 2, comprising:
a housing cover that separates the second interior from surroundings of the double seat valve, wherein the flushing space is formed in the housing cover, and the closing body portion can be received in the housing cover while exposing the seal.

16. The double seat valve according to claim 15, wherein the hygiene structure comprises a spray nozzle body, and the spray nozzle body is arranged in the flushing space so as to surround a hollow rod.

17. The double seat valve according to claim 2, wherein a surface normal of an underside of the closing body portion is inclined by a few degrees with respect to a stroke direction, such that a cone along the surface of which liquid flows off toward the center is formed.

18. The double seat valve according to claim 8, wherein the flushing space has sufficient dimensions to completely receive the closing body portion to form at least one gap.

19. The double seat valve according to claim 11, wherein the twist-off point is arranged on the closing body portion, adjoins the sliding surface in a direction of the second interior, and forms a gap with the seal in a cleaning position of the closing body portion.

20. The double seat valve according to claim 3, comprising:
a housing cover that separates the second interior from surroundings of the double seat valve, wherein the flushing space is formed in the housing cover, and the closing body portion can be received in the housing cover while exposing the seal.
